(19) United States
(12) Patent Application Publication
(10) Pub. No.: US 2026/0319225 A1
(43) Pub. Date: Oct. 15, 2026

(54) OPTICAL SYSTEM AND IMAGE CAPTURING APPARATUS INCLUDING OPTICAL SYSTEM

(71) Applicant: CANON KABUSHIKI KAISHA, Tokyo (JP)

(72) Inventor: YUICHI GYODA, Tochigi (JP)

(21) Appl. No.: 19/464,362

(22) Filed: Jan. 29, 2026

(30) Foreign Application Priority Data
Feb. 4, 2025 (JP) 2025-016871

(51) Int. Cl. G02B 13/00; G03B 17/17

(52) U.S. Cl. CPC G02B 13/0065; G03B 17/17

(57) ABSTRACT

To provide a small-sized optical system with high optical performance. The optical system includes, in order from an object side to an image side, a first lens having positive refractive power, a second lens having negative refractive power, a folding optical element, and a rear lens having negative refractive power, wherein the second lens is disposed adjacent to the first lens on the image side, and wherein a prescribed conditional expression is satisfied where NdG1 is a refractive index of a material of the first lens, and νdG1 is an Abbe number of the material of the first lens for a d-line.

### BACKGROUND

### Field of the Technology

Disclosure of the present specification relates to an optical system and an image capturing apparatus including the optical system, particularly relates to an image capturing optical system suitable for a camera included in a mobile terminal such as a smartphone, a digital still camera, and a video camera, and an image capturing apparatus including the image capturing optical system.

### Description of the Related Art

In recent years, an image capturing optical system used for image capturing apparatuses such as a camera included in a mobile terminal such as a smartphone, a digital still camera, and a video camera has been required to have high optical performance, and also to be small in size.

A telephotographic lens including a positive lens, a folding optical element, and a rear lens group including a plurality of lenses, sequentially arranged from an object side, is disclosed in the specification of United States Patent Application Publication No. 2021/0165192.

### SUMMARY

According to an aspect of the present disclosure, an optical system includes, in order from an object side to an image side, a first lens having positive refractive power, a second lens having negative refractive power, a folding optical element, and a rear lens having negative refractive power, wherein the second lens is disposed adjacent (arranged next) to the first lens on the image side, and wherein the following conditional expressions are satisfied:

1.30<NdG1<1.60

73.0<νdG1<120.0

where NdG1 is a refractive index of a material of the first lens, and νdG1 is an Abbe number of the material of the first lens for a d-line.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional diagram of an optical system according to Example 1.

FIG. 2 illustrates aberration diagrams of the optical system according to Example 1.

FIG. 3 is a cross-sectional diagram of an optical system according to Example 2.

FIG. 4 illustrates aberration diagrams of the optical system according to Example 2.

FIG. 5 is a cross-sectional diagram of an optical system according to Example 3.

FIG. 6 illustrates aberration diagrams of the optical system according to Example 3.

FIG. 7 is a cross-sectional diagram of an optical system according to Example 4.

FIG. 8 illustrates aberration diagrams of the optical system according to Example 4.

FIG. 9 is a cross-sectional diagram of an optical system according to Example 5.

FIG. 10 illustrates aberration diagrams of the optical system according to Example 5.

FIG. 11 is a cross-sectional diagram of an optical system according to Example 6.

FIG. 12 illustrates aberration diagrams of the optical system according to Example 6.

FIG. 13 is a cross-sectional diagram of an optical system according to Example 7.

FIG. 14 illustrates aberration diagrams of the optical system according to Example 7.

FIG. 15 is a cross-sectional diagram of an optical system according to Example 8.

FIG. 16 illustrates aberration diagrams of the optical system according to Example 8.

FIG. 17 is a cross-sectional diagram of an optical system according to Example 9.

FIG. 18 illustrates aberration diagrams of the optical system according to Example 9.

FIG. 19 is a cross-sectional diagram of an optical system according to Example 10.

FIG. 20 illustrates aberration diagrams of the optical system according to Example 10.

FIG. 21 is a cross-sectional diagram of an optical system according to Example 11.

FIG. 22 illustrates aberration diagrams of the optical system according to Example 11.

FIG. 23 is a cross-sectional diagram of an optical system according to Example 12.

FIG. 24 illustrates aberration diagrams of the optical system according to Example 12.

FIGS. 25A to 25C are diagrams illustrating examples of a folding optical element.

FIG. 26 is a schematic diagram illustrating main parts of an image capturing apparatus to which the optical system of each of the examples is applied.

### DESCRIPTION OF THE EMBODIMENTS

Embodiments disclosed in the present specification are described below in detail with reference to the appended drawings. In the drawings, the same reference numbers are applied to the same members, and duplicative descriptions are omitted.

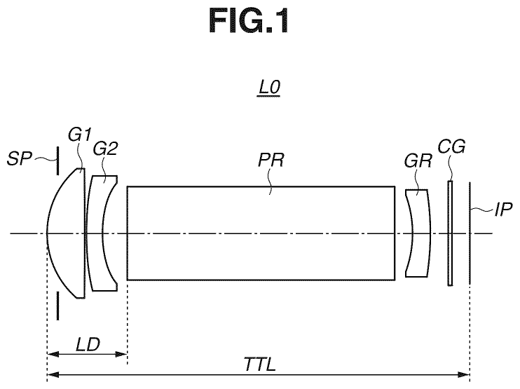

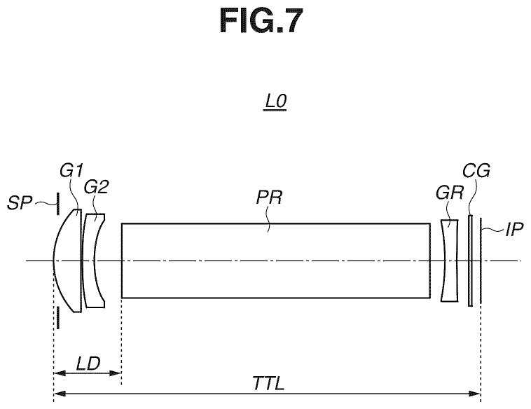

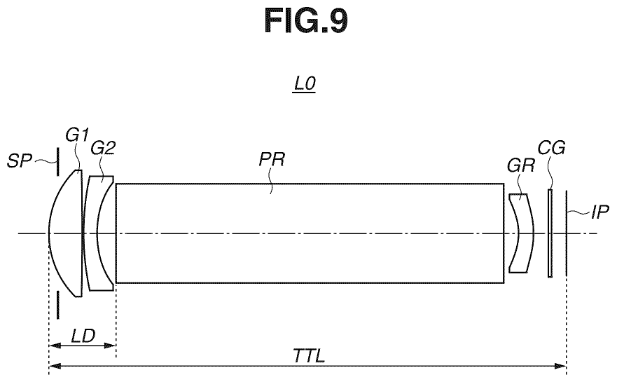

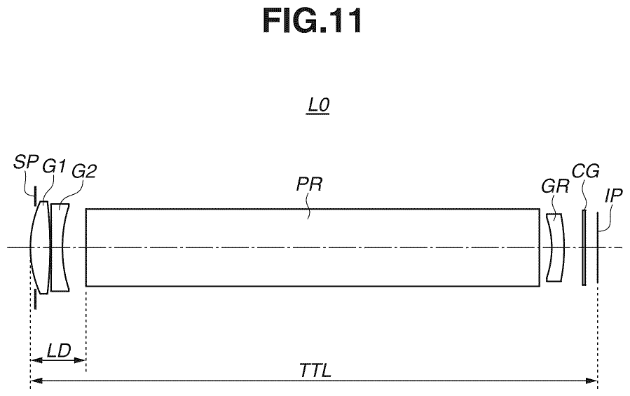

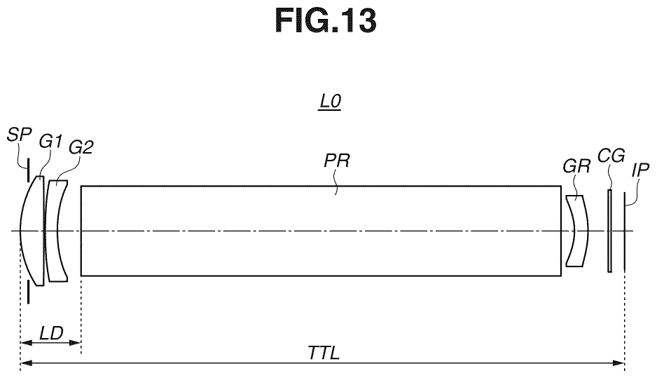

FIGS. 1, 3, 5, 7, 9, 11, 13, 15, 17, 19, 21, and 23 are cross-sectional diagrams of an optical system L0 according to each of Examples 1 to 12. The optical system L0 of each of the examples is used for image capturing apparatuses such as a digital still camera, a digital video camera, a monitoring camera, an in-vehicle camera, and a smartphone.

In each of the cross-sectional diagrams, a left side is an object side (front side), and a right side is an image side (rear side). An aperture stop SP determines (limits) a light flux of a maximum aperture F-number (Fno). The optical system L0 of each of the examples includes a plurality of lenses or optical elements. The optical system L0 of each of the examples may also include an aspheric lens, a Fresnel lens, a meta-surface lens, a diffraction optical element, and an optical element such as a cover glass which does not practically have refractive power.

In a case where the optical system of each of the examples is used for an image capturing apparatus, such as a camera included in a mobile terminal, a video camera, and a digital camera, an image plane IP corresponds to a solid-state image sensor (photoelectric conversion element) such as a charge-coupled device (CCD) sensor or a complementary metal-oxide semiconductor (CMOS) sensor. When the optical system of each of the examples is used for an image capturing apparatus such as a silver-halide film camera, the image plane IP corresponds to a film surface.

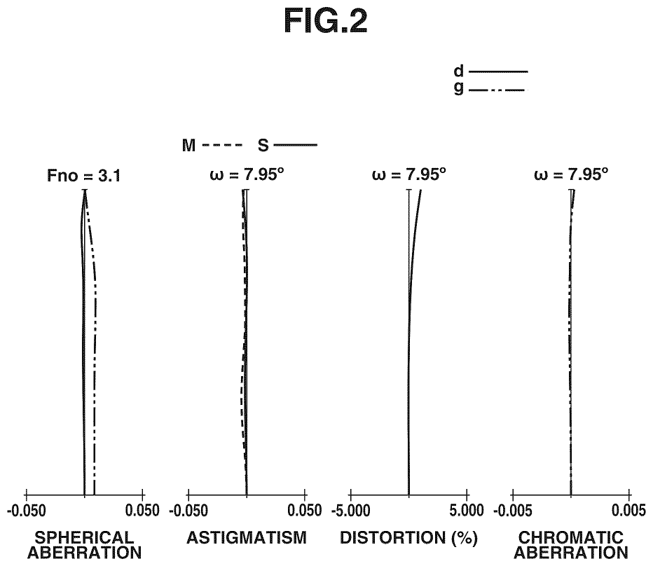

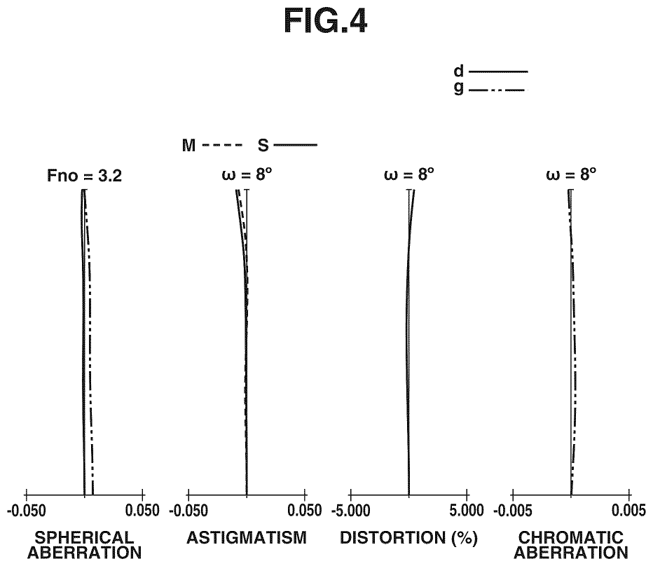

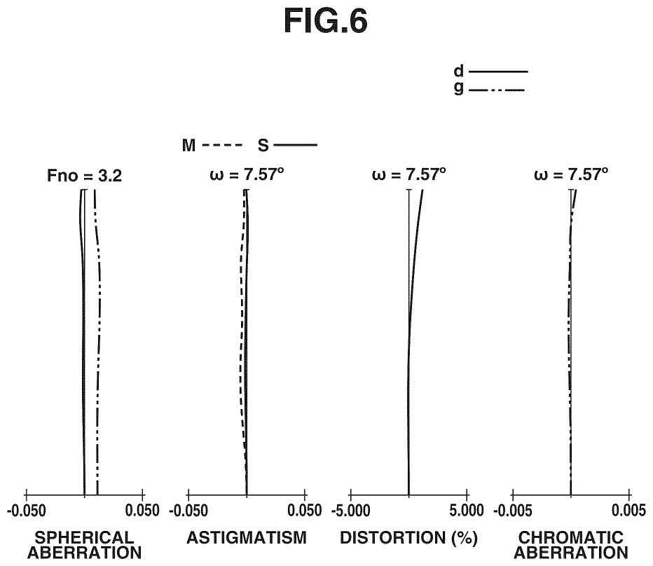

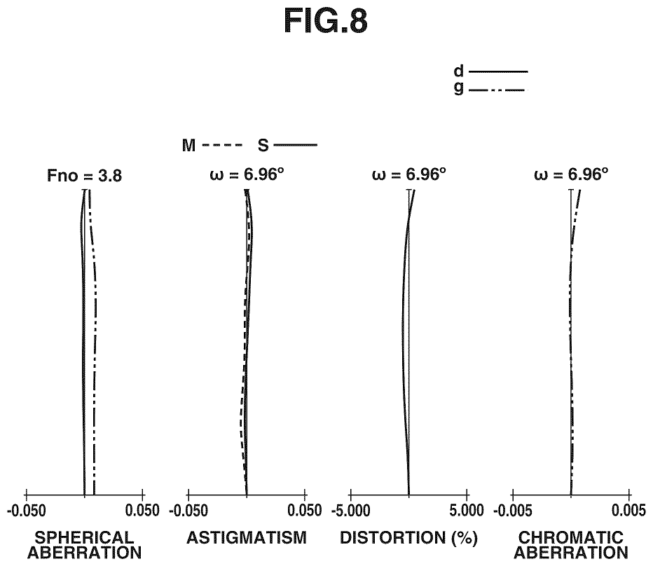

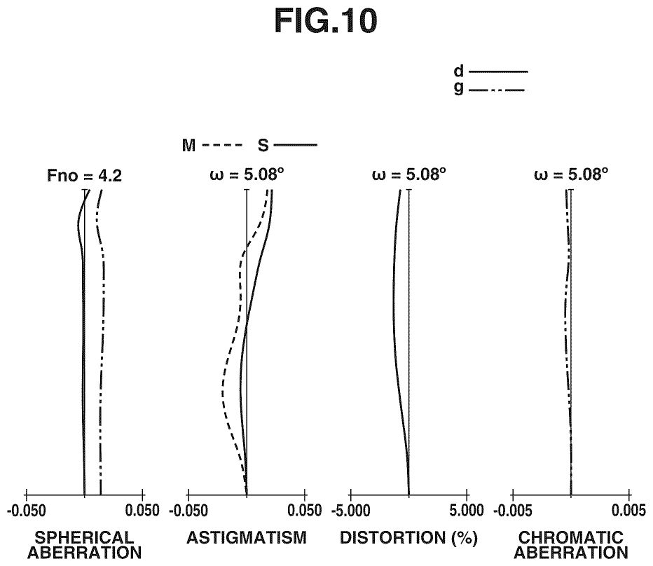

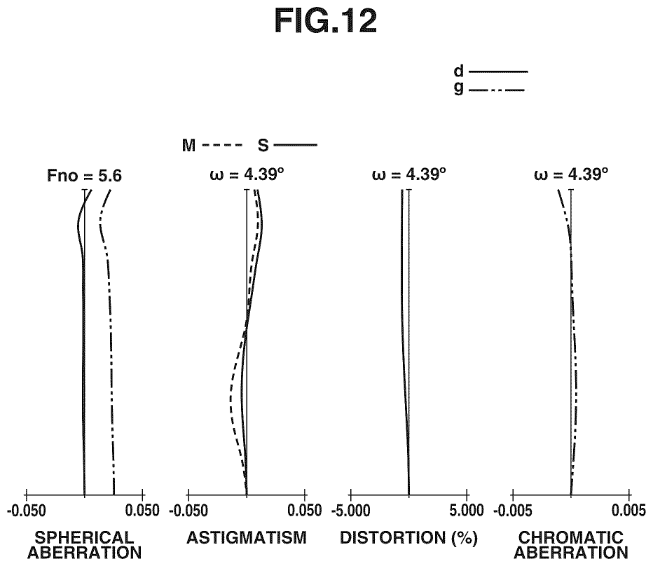

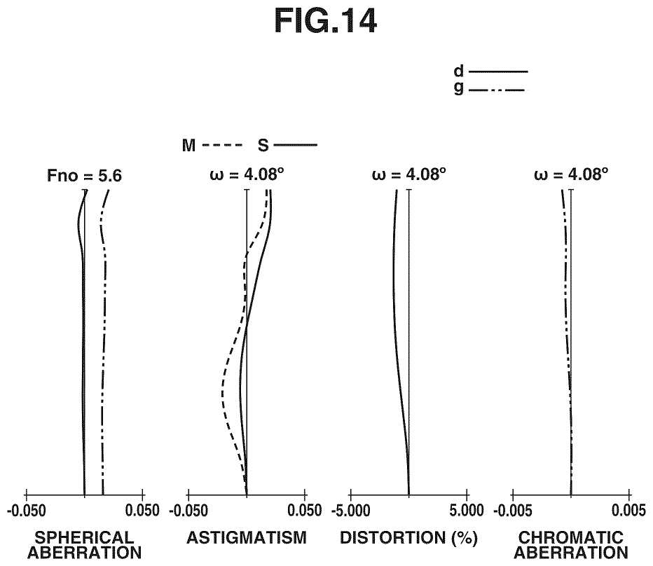

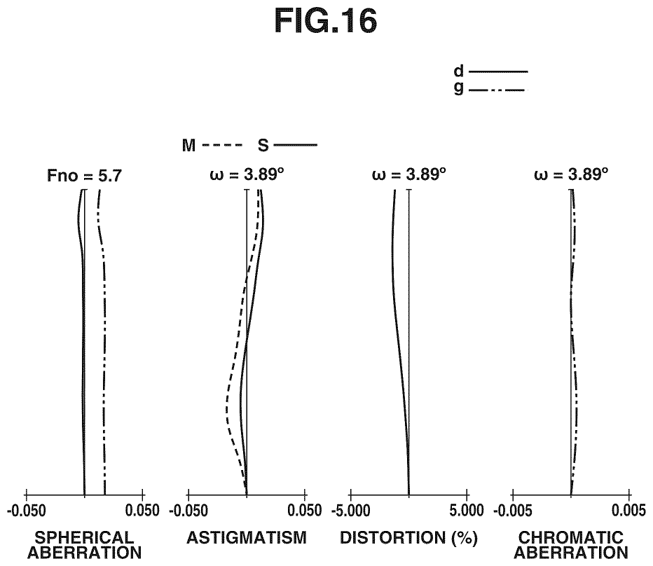

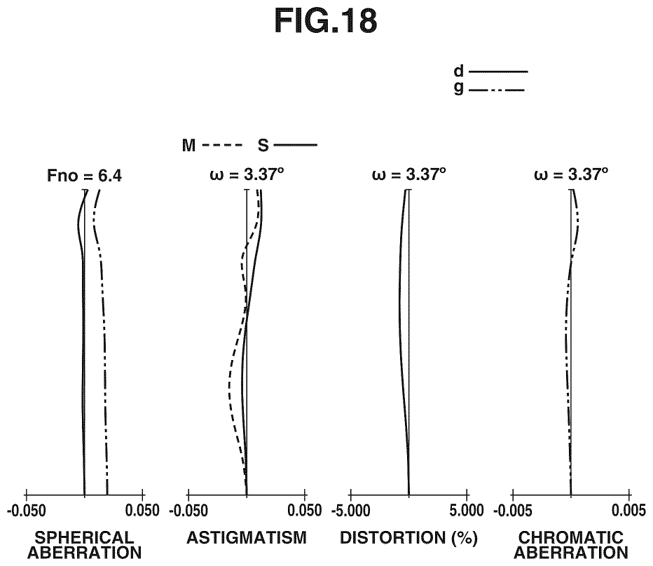

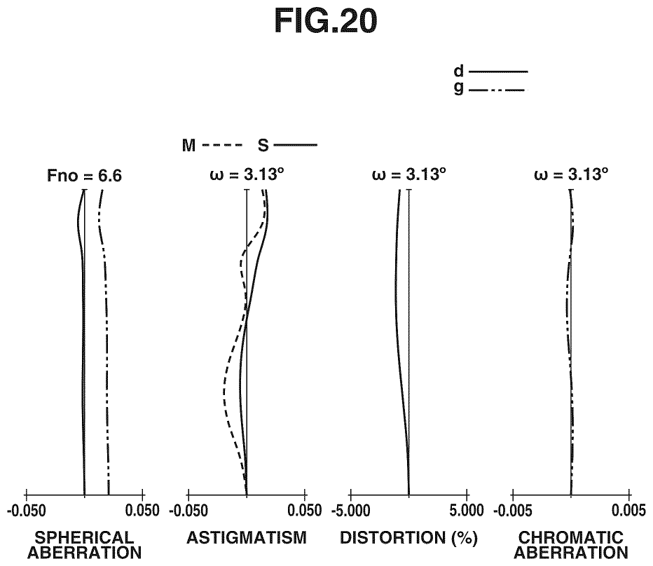

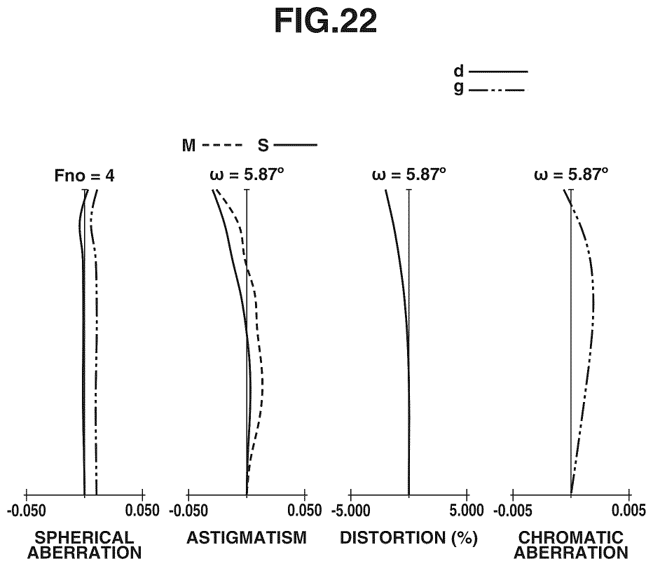

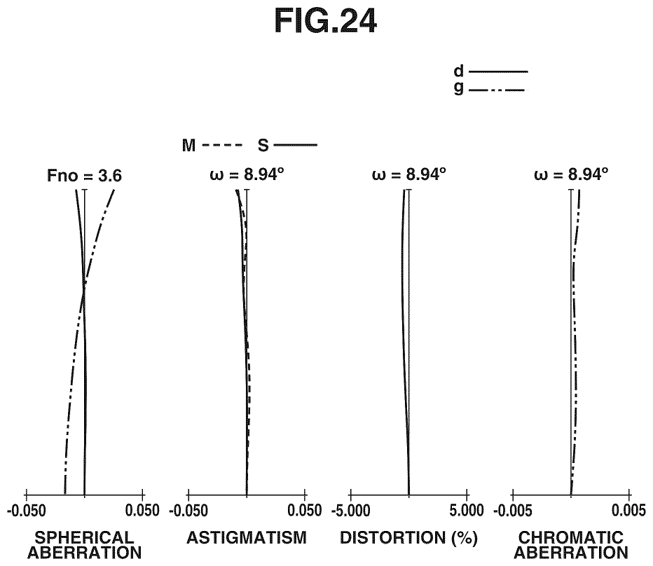

FIGS. 2, 4, 6, 8, 10, 12, 14, 16, 18, 20, 22, and 24 illustrate aberration diagrams of the optical system L0 of each of Examples 1 to 12 when focused at infinity.

In a spherical aberration diagram, Fno indicates an F-number, a solid line indicates a spherical aberration for a d-line (a wavelength of 587.6 nm), and a dashed-double-dotted line indicates a spherical aberration for a g-line (a wavelength of 435.8 nm). In an astigmatism diagram, a solid line S indicates a sagittal image plane, and a dashed line M indicates a meridional image plane. A distortion aberration diagram indicates a distortion aberration for the d-line. A chromatic aberration diagram indicates a chromatic aberration for the g-line. Further, ω is a half-angle of view (in degrees, °).

Next, characteristic configuration of the optical system L0 of each of the examples is described.

The optical system L0 of each of the examples includes a first lens G1 having positive refractive power, a second lens G2 having negative refractive power, a folding optical element PR for folding a light path, and a rear lens GR having negative refractive power, sequentially arranged from the object side to the image side.

By arranging a positive lens and a negative lens as the first lens G1 and the second lens G2 respectively, the lenses are arranged in a so-called telephoto-type optical power arrangement, so that the light ray is strongly converged by the first lens G1. Therefore, the optical system L0 can be reduced in size.

The folding optical element PR has a function for folding an incident light flux. An optical element such as a prism or a mirror, including a reflection surface, corresponds to the folding optical element PR. The folding optical element PR is described below in detail. The optical system L0 has a characteristic in which a height of an axial light ray becomes low whereas a height of an off-axis light ray becomes high in a space between the folding optical element PR and the image plane IP. Therefore, off-axis aberrations such as an astigmatism and a coma aberration can effectively be corrected by arranging the negative rear lens GR on the image side of the folding optical element PR.

Next, conditions desirable for the optical system L0 of each of the examples to satisfy are described.

It is desirable for the optical system L0 of each of the examples to satisfy one or more of the following conditional expressions (1) to (14).

1.30<NdG1<1.60 (1)

65.0<νdG1<120.0 (2)

0.20<|fG2/f|<4.00 (3)

0.10<|fGR/f|<2.00 (4)

0.20<fG1/f<1.00 (5)

0.20<|fGR/fG1|<3.00 (6)

−2.00<(G1R1+G1R2)/(G1R1−G1R2)<0.50 (7)

−3.00<(G2R1+G2R2)/(G2R1−G2R2)<7.00 (8)

−8.00<(GRR1+GRR2)/(GRR1−GRR2)<1.00 (9)

0.005<θgFG1−0.6438+0.001682×νdG1<0.100 (10)

0.01<LD/f<0.60 (11)

0.40<TTL/f<4.00 (12)

1<ω<20 (13)

0.20<EA_IMG/EA_OBJ<1.00 (14)

In each of the conditional expressions, numerical values are expressed as follows.

NdG1 is a refractive index of the material of the first lens G1 for the d-line, νdG1 is an Abbe number of the material of the first lens G1 for the d-line, and νdG2 is an Abbe number of the material of the second lens G2 for the d-line.

f is a focal length of the entire optical system L0, and TTL is a total optical length of the optical system L0.

fG1 is a focal length of the first lens G1, fG2 is a focal length of the second lens G2, and fGR is a focal length of the rear lens GR.

LD is a distance from an object-side lens surface of the first lens G1 to an object-side lens surface of the folding optical element PR on the optical axis.

ω is an imaging half-angle of view (in degrees, °) of the optical system L0 for the maximum image height.

G1R1 is a curvature radius of the object-side lens surface of the first lens G1, and G1R2 is a curvature radius of the image-side lens surface of the first lens G1.

G2R1 is a curvature radius of an object-side lens surface of the second lens G2, and G2R2 is a curvature radius of an image-side lens surface of the second lens G2.

GRR1 is a curvature radius of an object-side lens surface of the rear lens GR, and GRR2 is a curvature radius of an image-side lens surface of the rear lens GR.

θgFG1 is a partial dispersion ratio of the material of the first lens G1.

EA_OBJ is a light ray effective diameter of an object-side lens surface of a lens arranged closest to the object side of the optical system L0, and EA_IMG is a light ray effective diameter of an image-side lens surface of a lens arranged closest to the image side of the optical system L0.

The conditional expression (1) defines a refractive index of the first lens G1 for the d-line. A value greater than the upper limit defined by the conditional expression (1) is not desirable because dispersion of the material of the first lens G1 is increased, so that the chromatic aberration is corrected excessively. A value less than the lower limit defined by the conditional expression (1) is not desirable because a refractive index of the first lens G1 is reduced, so that a curvature radius of the first lens G1 is increased, and a size of the optical system L0 is increased in the optical axis direction.

Further, it is desirable that the upper limit defined by the conditional expression (1) be any one of 1.595, 1.590, 1.585, 1.580, 1.575, 1.570, 1.565, 1.560, 1.555, 1.550, 1.545, 1.540, 1.535, and 1.530.

Further, it is desirable that the lower limit defined by the conditional expression (1) be any one of 1.31, 1.32, 1.33, 1.34, 1.35, 1.36, 1.37, 1.38, 1.39, 1.40. 1.41, 1.42, and 1.43.

The conditional expression (2) defines an Abbe number of the first lens G1 for the d-line. A value greater than the upper limit defined by the conditional expression (2) is not desirable because the chromatic aberration is corrected excessively. A value less than the lower limit defined by the conditional expression (2) is not desirable because the axial chromatic aberration and the lateral chromatic aberration arising in the first lens G1 become too large, so that it is difficult to satisfactory correct the chromatic aberration in the entire optical system.

Further, it is desirable that the upper limit defined by the conditional expression (2) be any one of 118.0, 116.0, 114.0, 112.0, 110.0, 108.0, 106.0, 104.0, 102.0, 100.0, 99.0, 98.0, 97.0, 96.0, and 95.0.

Furthermore, it is desirable that the lower limit defined by the conditional expression (2) be any one of 66.0, 67.0, 68.0, 69.0, 70.0, 71.0, 72.0, 73.0, 74.0, 75.0, 76.0, 77.0, 78.0, 79.0, 80.0, and 81.0.

The conditional expression (3) defines the refractive power of the second lens G2. A value greater than the upper limit defined by the conditional expression (3) is not desirable because the refractive power of the second lens G2 becomes too weak, so that it is difficult to correct the spherical aberration and the axial chromatic aberration arising in the first lens G1 by the second lens G2. A value less than the lower limit defined by the conditional expression (3) is not desirable because the refractive power of the second lens G2 becomes too strong, so that the spherical aberration and the astigmatism arising in the first lens G1 are corrected excessively.

The conditional expression (4) defines the refractive power of the rear lens GR. A value greater than the upper limit defined by the conditional expression (4) is not desirable because the refractive power of the rear lens GR becomes too weak, so that it is difficult to correct the spherical aberration and the axial chromatic aberration arising in the object side of the rear lens GR by the rear lens GR. A value less than the lower limit defined by the conditional expression (4) is not desirable because the refractive power of the rear lens GR becomes too strong, so that the coma aberration and the astigmatism are corrected excessively.

The conditional expression (5) defines the refractive power of the first lens G1. A value greater than the upper limit defined by the conditional expression (5) is not desirable because the refractive power of the first lens G1 becomes too weak, so that a height of a light ray incident on the lens arranged on the image side of the first lens G1 becomes high, and a diameter of the lens arranged on the image side of the first lens G1 is increased. A value less than the lower limit defined by the conditional expression (5) is not desirable because the refractive power of the first lens G1 becomes too strong, so that the spherical aberration and the coma aberration arise strongly.

The conditional expression (6) defines a ratio of the refractive powers of the first lens G1 and the rear lens GR. A value greater than the upper limit defined by the conditional expression (6) is not desirable because the refractive power of the rear lens GR becomes too weak with respect to the refractive power of the first lens G1, so that it is difficult to correct the astigmatism and the lateral chromatic aberration arising in the first lens G1 by the rear lens GR. A value less than the lower limit defined by the conditional expression (6) is not desirable because the refractive power of the rear lens GR becomes too strong, so that the astigmatism and the distortion aberration arise strongly.

The conditional expression (7) defines a shape of the lens surface of the first lens G1. A value greater than the upper limit defined by the conditional expression (7) is not desirable because the image-side lens surface of the first lens G1 becomes a concave surface with strong concavity facing toward the object side, so that the coma aberration strongly arises in the first lens G1. A value less than the lower limit defined by the conditional expression (7) is not desirable because the first lens G1 becomes a meniscus lens with strong convexity facing toward the object side, so that the spherical aberration strongly arises in the first lens G1.

The conditional expression (8) defines a shape of the lens surface of the second lens G2. A value greater than the upper limit defined by the conditional expression (8) is not desirable because the second lens G2 becomes a meniscus lens with strong convexity facing toward the object side, so that the spherical aberration is corrected excessively. A value less than the lower limit defined by the conditional expression (8) is not desirable because the second lens G2 becomes a meniscus lens with strong concavity facing toward the object side, so that a light ray cannot be converged by the second lens G2, and thus it is difficult to reduce the diameters of the optical elements subsequent to the second lens G2.

The conditional expression (9) defines a shape of the lens surface of the rear lens GR. A value greater than the upper limit defined by the conditional expression (9) is not desirable because the rear lens GR becomes a meniscus lens with strong concavity facing toward the object side, so that the spherical aberration is corrected excessively. A value less than the lower limit defined by the conditional expression (9) is not desirable because the second lens G2 becomes a meniscus lens with strong convexity facing toward the object side, so that the lateral chromatic aberration and the coma aberration are corrected excessively.

The conditional expression (10) defines a partial dispersion ratio of the material of the first lens G1 for the g-line and the F-line. A value greater than the upper limit defined by the conditional expression (10) is not desirable because the axial chromatic aberration and the lateral chromatic aberration are corrected excessively. A value less than the lower limit defined by the conditional expression (10) is not desirable because the axial chromatic aberration and the lateral chromatic aberration are not corrected sufficiently.

The conditional expression (11) defines a distance from the object-side lens surface of the first lens G1 to the object-side lens surface of the folding optical element PR on the optical axis. A value greater than the upper limit defined by the conditional expression (11) is not desirable because a distance from the first lens G1 to the folding optical element PR on the optical axis is increased, so that a size of the optical system L0 is increased in the optical axis direction. A value less than the lower limit defined by the conditional expression (11) is not desirable because thicknesses of the first and the second lenses G1 and G2 arranged on the object side of the folding optical element PR are reduced, so that the refractive powers of the first and the second lenses G1 and G2 become too weak.

The conditional expression (12) defines a ratio between the total optical length of the optical system L0 and the focal length of the entire optical system L0. Herein, the total optical length refers to a distance from a lens surface closest to the object side to the image plane on the optical axis. In a case where optical elements such as a cover glass and a folding optical element, which do not practically have refractive powers, are arranged further on the object side of the lens surface closest to the object side, these optical elements are not taken into consideration when calculating the total optical length. A value greater than the upper limit defined by the conditional expression (12) is not desirable because the total optical length of the optical system L0 becomes too long, so that a size of the optical system L0 is increased in the optical axis direction. A value less than the lower limit defined by the conditional expression (12) is not desirable because the refractive powers of the first lens G1 and the second lens G2 become too strong, so that it is difficult to correct the various aberrations.

The conditional expression (13) defines a desirable range of the half-angle of view of the optical system L0 for the maximum image height. The maximum image height of the optical system L0 is a distance from a position at the image plane IP, where the peripheral light amount becomes 10%, to the optical axis, when the light amount of a position on the optical axis is 100%. A value greater than the upper limit defined by the conditional expression (13) is not desirable because Fno becomes too small, so that lens diameters of the lenses included in the optical system L0 are increased, and thus a size of the optical system L0 is increased in the diameter direction. A value less than the lower limit defined by the conditional expression (13) is not desirable because a height of a light ray incident on the first lens G1 becomes too low, so that the total optical length TTL is increased, and thus a size of the optical system L0 is increased in the optical axis direction.

The conditional expression (14) defines a ratio between a light ray effective diameter of an object-side lens surface of a lens arranged closest to the object side and a light ray effective diameter of an image-side lens surface of a lens arranged closest to the image side in the optical system L0. Herein, the lens refers to a lens having refractive power. Therefore, effective diameters of the optical elements, such as a cover glass, a mirror, and a prism, which do not practically have refractive powers, are not included in this conditional expression.

A value greater than the upper limit defined by the conditional expression (14) is not desirable because a lens diameter of the lens arranged closest to the image side of the optical system L0 becomes too large, so that a size of the optical system L0 is increased in the diameter direction. A value less than the lower limit defined by the conditional expression (14) is not desirable because the refractive power of the lens arranged closest to the image side of the optical system L0 becomes too strong, so that it is difficult to correct the various aberrations.

Further, it is more desirable that the numerical ranges of the conditional expressions (1) to (14) be numerical ranges defined by the following conditional expressions (1a) to (14a).

1.40<NdG1<1.57 (1a)

73.0<νdG1<110.0 (2a)

0.30<|fG2/f|<3.00 (3a)

0.15<|fGR/f|<1.50 (4a)

0.25<fG1/f<0.80 (5a)

0.50<|fGR/fG1|<2.70 (6a)

−1.80<(G1R1+G1R2)/(G1R1−G1R2)<0.30 (7a)

−2.00<(G2R1+G2R2)/(G2R1−G2R2)<6.00 (8a)

−7.00<(GRR1+GRR2)/(GRR1−GRR2)<0.60 (9a)

0.010<θgFG1−0.6438+0.001682×νdG1<0.080 (10a)

0.05<LD/f<0.50 (11a)

0.60<TTL/f<3.00 (12a)

2<ω<15 (13a)

0.35<EA_IMG/EA_OBJ<0.95 (14a)

Furthermore, it is more desirable that the numerical ranges of the conditional expressions (1) to (14) be numerical ranges defined by the following conditional expressions (1b) to (14b).

1.42<NdG1<1.55 (1b)

85.0<νdG1<100.0 (2b)

0.40<|fG2/f|<2.50 (3b)

0.30<|fGR/f|<1.20 (4b)

0.30<fG1/f<0.70 (5b)

0.70<|fGR/fG1|<2.40 (6b)

−1.50<(G1R1+G1R2)/(G1R1−G1R2)<0.10 (7b)

−0.50<(G2R1+G2R2)/(G2R1−G2R2)<5.00 (8b)

−6.00<(GRR1+GRR2)/(GRR1−GRR2)<2.00 (9b)

0.020<θgFG1−0.6438+0.001682×νdG1<0.050 (10b)

0.07<LD/f<0.40 (11b)

0.80<TTL/f<2.00 (12b)

3<ω<12 (13b)

0.50<EA_IMG/EA_OBJ<0.90 (14b)

Next, configuration desirable for the optical system L0 of each of the examples to satisfy is described.

In the optical system L0 of each of the examples, it is desirable that the folding optical element PR be arranged next to the second lens G2 on the image side. In this way, a height of an axial light ray passing through the second lens G2 can be increased, so that the spherical aberration and the axial chromatic aberration can be corrected satisfactory.

In the optical system L0 of each of the examples, it is desirable that at least one of the object-side lens surface and the image-side lens surface of the first lens G1 have an aspheric shape. By arranging an aspheric lens as the first lens G1, the spherical aberration and the coma aberration arising in the first lens G1 can be reduced. Further, in order to increase the above-described effect, it is desirable that the aspheric shape of at least one of the object-side lens surface and the image-side lens surface of the first lens G1 be a shape for weakening positive refractive power toward the circumference from the optical axis center.

Here, a shape for weakening refractive power toward a circumference from an optical axis center is described. The above-described shape refers to a shape which makes the refractive power at the optical axis center be the strongest, the refractive power at a point where the image height becomes 50% be weaker than the refractive power at the optical axis center, and the refractive power at a circumference be even weaker, when the refractive powers at the optical axis center, at the point where the image height becomes 50%, and at the circumference are compared to each other. In addition, the same can also be said for the shape for weakening the refractive power toward the circumference from the optical axis center.

In the optical system L0 of each of the examples, it is desirable that at least one of the object-side lens surface and the image-side lens surface of the second lens G2 have an aspheric shape. By arranging an aspheric lens as the second lens G2, the spherical aberration, the coma aberration, and the astigmatism arising in the first lens G1 can be corrected satisfactory. Further, in order to further increase the above-described effect, it is desirable that the aspheric shape of at least one of the object-side lens surface and the image-side lens surface of the second lens G2 be a shape for strengthening negative refractive power toward the circumference from the optical axis center.

In the optical system L0 of each of the examples, it is desirable that at least one of the object-side lens surface and the image-side lens surface of the rear lens GR have an aspheric shape. By arranging an aspheric lens as the rear lens GR, the coma aberration and the astigmatism arising in the first lens G1 can be corrected satisfactory.

In the optical system L0 of each of the examples, it is desirable that the second lens G2 be a lens made of a resinous material. In this way, a weight of the second lens G2 can be reduced, so that reduction in size of the optical system L0 can be realized.

In the optical system L0 of each of the examples, it is desirable that the rear lens GR be a lens made of a resinous material. In this way, a weight of the rear lens GR can be reduced, so that reduction in size of the optical system L0 can be realized.

In the optical system L0 of each of the examples, it is desirable that the folding optical element PR reflects a light ray for a plurality of times. By folding a light ray for a plurality of times, a total length of the optical system L0 can be shortened, so that reduction in size of the optical system L0 can be realized.

In the optical system L0 of each of the examples, it is desirable that the number of lenses having refractive power be four or less, from among the optical elements included in the optical system L0. By reducing the number of lenses included in the optical system L0, reduction in size of the optical system L0 can be realized.

Next, the optical system L0 of each of Examples 1 to 12 is described in detail. Configuration of the optical systems L0 of the examples different from configuration of the optical system L0 of Example 1 is mainly described, while description of configuration similar to each other is omitted.

### Example 1

FIG. 1 is a cross-sectional diagram of the optical system L0 of Example 1. The optical system L0 of Example 1 includes an aperture stop SP, a first lens G1 having positive refractive power, a second lens G2 having negative refractive power, a folding optical element PR, and a rear lens GR, sequentially arranged from the object side. The second lens G2 is a meniscus lens with convexity facing the object side.

In the optical system L0 of Example 1, the folding optical element PR is arranged next to the second lens G2 on the image side. In this way, a height of an axial light ray passing through the second lens G2 can be increased, so that the spherical aberration and the axial chromatic aberration can be corrected satisfactory.

In the optical system L0 of Example 1, the image-side lens surface of the first lens G1 has an aspheric shape for weakening positive refractive power toward the circumference from the optical axis center. Further, the object-side lens surface of the second lens G2 has an aspheric shape for strengthening negative refractive power toward the circumference from the optical axis center.

In the optical system L0 of Example 1, the second lens G2 and the rear lens GR are made of resinous materials.

### Example 2

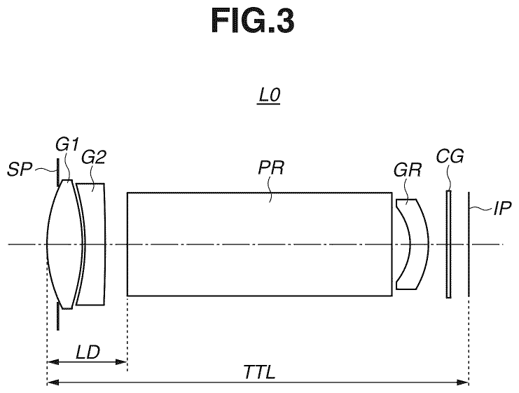

FIG. 3 is a cross-sectional diagram of the optical system L0 of Example 2. The optical system L0 of Example 2 includes an aperture stop SP, a first lens G1 having positive refractive power, a second lens G2 having negative refractive power, a folding optical element PR, and a rear lens GR, sequentially arranged from the object side. The second lens G2 is a meniscus lens with convexity facing toward the image side.

### Examples 3 to 7

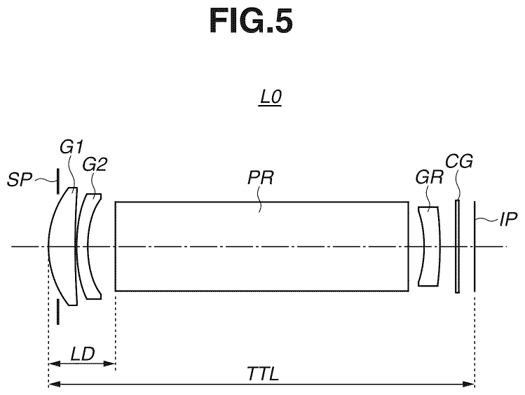

FIGS. 5, 7, 9, 11, and 13 are cross-sectional diagrams of the optical systems L0 of Examples 3 to 7. The optical system L0 of each of Examples 3 to 7 includes an aperture stop SP, a first lens G1 having positive refractive power, a second lens G2 having negative refractive power, a folding optical element PR, and a rear lens GR, sequentially arranged from the object side. The second lens G2 is a meniscus lens with convexity facing toward the object side.

### Example 8

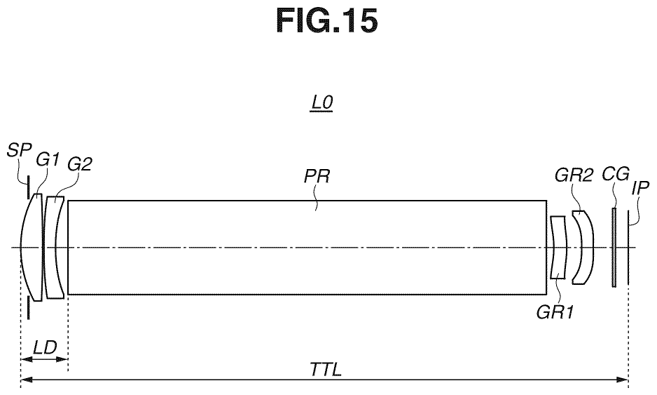

FIG. 15 is a cross-sectional diagram of the optical system L0 of Example 8. The optical system L0 of Example 8 includes an aperture stop SP, a first lens G1 having positive refractive power, a second lens G2 having negative refractive power, a folding optical element PR, and rear lenses GR1 and GR2 having negative refractive power, sequentially arranged from the object side. The second lens G2 is a meniscus lens with convexity facing toward the object side. The rear lens GR2 is a meniscus lens with convexity facing toward the image side.

In the optical system L0 of Example 8, the two rear lenses GR1 and GR2 having negative refractive power are arranged on the image side of the folding optical element PR. In order to satisfactory correct off-axis aberrations such as the astigmatism and the coma aberration, it is desirable for the optical system L0 to have negative refractive power on the image side of the folding optical element PR. Because the negative refractive power is shared by the two rear lenses GR1 and GR2, refractive power for one negative lens can be weakened. Therefore, occurrence of a pincushion distortion and a field curvature can be suppressed.

### Examples 9 and 10

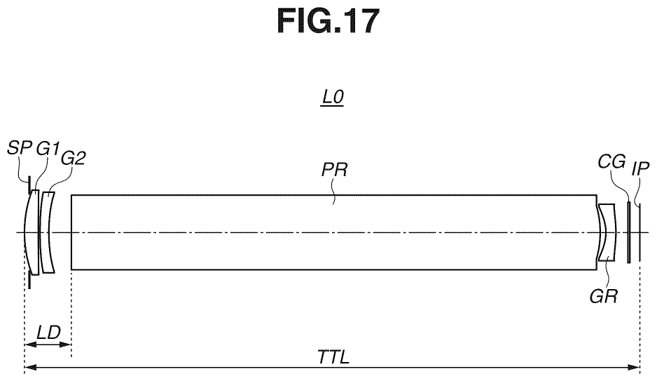

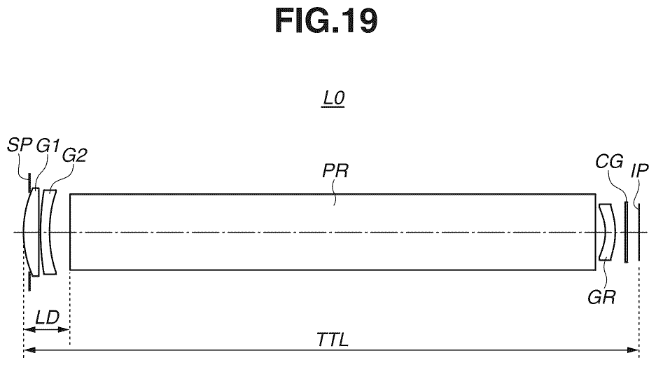

FIGS. 17 and 19 are cross-sectional diagrams of the optical systems L0 of Example 9 and 10. The optical system L0 of each of Examples 9 and 10 includes an aperture stop SP, a first lens G1 having positive refractive power, a second lens G2 having negative refractive power, a folding optical element PR, and a rear lens GR, sequentially arranged from the object side. The second lens G2 is a meniscus lens with convexity facing toward the object side.

### Example 11

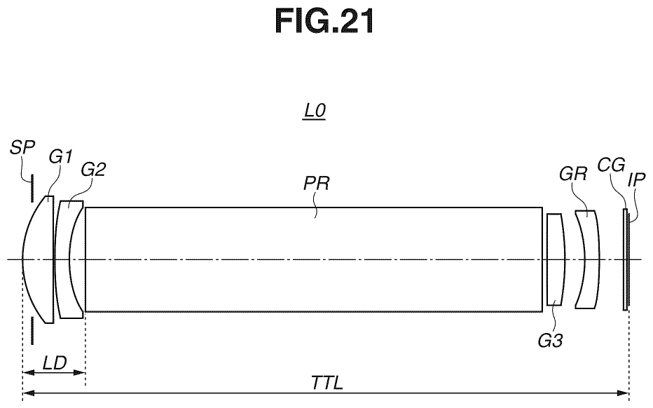

FIG. 21 is a cross-sectional diagram of the optical system L0 of Example 11. The optical system L0 of Example 11 includes an aperture stop SP, a first lens G1 having positive refractive power, a second lens G2 having negative refractive power, a third lens G3 having positive refractive power, a folding optical element PR, and rear lenses GR having negative refractive power, which are sequentially arranged from the object side. The second lens G2 is a meniscus lens with convexity facing toward the object side. The rear lens GR is a meniscus lens with convexity facing toward the image side.

### Example 12

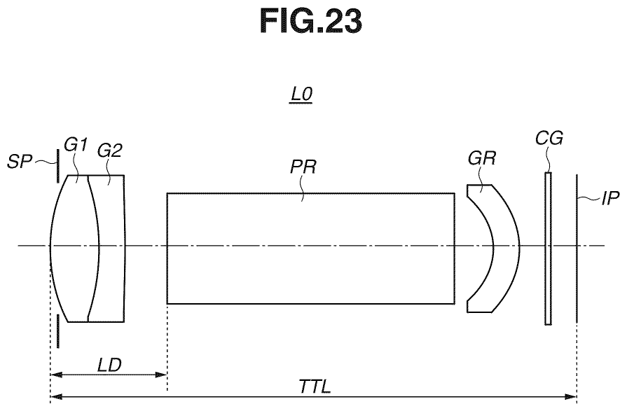

FIG. 23 is a cross-sectional diagram of the optical system L0 of Example 12. The optical system L0 of Example 12 includes an aperture stop SP, a first lens G1 having positive refractive power, a second lens G2 having negative refractive power, a folding optical element PR, and a rear lens GR having negative refractive power, which are sequentially arranged from the object side. The first lens G1 and the second lens G2 are joined to each other. The second lens G2 is a meniscus lens with convexity facing toward the image side. The rear lens GR is a meniscus lens with convexity facing toward the image side.

In the optical system L0 of Example 12, the first lens G1 and the second lens G2 are joined to each other. In this way, eccentric errors arising in the first lens G1 and the second lens G2 can be suppressed, so that the optical performance of the optical system L0 can be improved.

Numerical examples 1 to 12 for the respective examples 1 to 12 are described below. In each of the numerical examples, a surface number i indicates order of surfaces counted from the object side. r is a curvature radius (mm) of the i-th surface from the object side, d is a lens thickness (mm) or an air space (mm) between the i-th surface and the (i+1)-th surface on the optical axis, and nd is a refractive index for the d-line of an optical material between the i-th surface and the (i+1)-th surface. In addition, a symbol d takes a direction heading toward the image side from the object side on the optical axis as positive. νd is an Abbe number of the optical material between the i-th surface and the (i+1)-th surface, which takes the d-line as a reference. θgF is a partial dispersion ratio of the optical material between the i-th surface and the (i+1)-th surface.

BF is a back focal length (mm) described above. The total optical length is a distance from a lens surface (forefront surface) located closest to the object side to the image plane of the optical system L0 on the optical axis. In a case where an optical surface is an aspheric surface, a symbol * is applied to the right side of the surface number. An aspheric shape is expressed by the following expression when X is a displacement from a surface vertex in the optical axis direction, h is a height from the optical axis in a direction perpendicular to the optical axis, R is a paraxial curvature radius, k is a conic constant, and A4, A6, A8, A10, and A12 are aspheric coefficients for respective orders. X=(h²/R)/[1+(1−(1+k)(h/R)²))^{1/2}+A4×h⁴+A6×h⁶+A8×h⁸+A10×h¹⁰+A12×h¹²

“e±XX” described in each of the aspheric coefficients represents “×10±^{xx}”.

### Numerical Example 1

Unit: mm
Surface Data

| Surface | | | | | Effective | |
|---|---|---|---|---|---|---|
| Number | r | d | nd | νd | Diameter | θgF |
| 1 (Aperture) | ∞ | −0.60 | 6.45 | | | |
| 2 | 4.731 | 2.11 | 1.43875 | 94.7 | 6.45 | 0.5340 |
| 3 | −411.548 | 0.10 | 6.02 | | | |
| 4* | 20.895 | 0.90 | 1.53160 | 55.8 | 5.72 | |
| 5* | 7.528 | 1.39 | 4.93 | | | |
| 6 | ∞ | 15.00 | 1.76200 | 40.1 | 4.60 | |
| 7 | ∞ | 1.00 | 3.70 | | | |
| 8* | −6.272 | 1.00 | 1.66080 | 20.4 | 3.90 | |
| 9* | −16.327 | 1.00 | 4.40 | | | |
| 10 | ∞ | 0.21 | 1.51633 | 64.1 | 5.03 | |
| 11 | ∞ | 1.00 | 5.10 | | | |
| Image Plane | ∞ | | | | | |

Aspheric Surface Data

| | | |
|---|---|---|
| The 4th Surface | K = 0.00000e+00 | A4 = 1.39988e−03 |
| | A6 = −5.00672e−05 | A8 = −9.47095e−08 |
| | A10 = 8.26830e−08 | A12 = −5.10207e−09 |
| The 5th Surface | K = 0.00000e+00 | A4 = 3.29520e−03 |
| | A6 = 4.26593e−05 | A8 = 5.32375e−06 |
| | A10 = −3.21358e−08 | A12 = 6.50926e−08 |
| The 8th Surface | K = 0.00000e+00 | A4 = −6.21881e−04 |
| | A6 = −5.03177e−04 | A8 = 3.40052e−04 |
| | A10 = −7.01441e−05 | A12 = 5.50076e−06 |
| The 9th Surface | K = 0.00000e+00 | A4 = −1.53138e−03 |
| | A6 = −6.36534e−05 | A8 = 1.19314e−04 |
| | A10 = −1.98225e−05 | A12 = 1.19326e−06 |

| | |
|---|---|
| Focal Length | 20.00 |
| F-Number | 3.10 |
| Half Angle of View | 7.95 |
| Image Height | 2.82 |
| BF | 1.00 |

Single Lens Data

| Lens | Beginning Surface | Focal Length |
|---|---|---|
| G1 | 1 | 10.68 |
| G2 | 4 | −22.66 |
| PR | 6 | INF |
| G3 | 8 | −16.05 |
| CG | 10 | INF |

### Numerical Example 2

Unit: mm
Surface Data

| Surface | | | | | Effective | |
|---|---|---|---|---|---|---|
| Number | r | d | nd | νd | Diameter | θgF |
| 1 (Aperture) | ∞ | −0.60 | 6.25 | | | |
| 2 | 7.591 | 1.94 | 1.43875 | 94.7 | 6.25 | 0.5340 |
| 3* | −8.723 | 0.15 | 6.03 | | | |
| 4* | −10.065 | 1.10 | 1.53160 | 55.8 | 5.89 | |
| 5* | −73.130 | 1.21 | 5.55 | | | |
| 6 | ∞ | 14.50 | 1.51742 | 52.4 | 5.03 | |
| 7 | ∞ | 1.00 | 3.63 | | | |
| 8* | −3.043 | 1.00 | 1.61550 | 25.8 | 3.73 | |
| 9* | −4.845 | 1.00 | 4.44 | | | |
| 10 | ∞ | 0.21 | 1.51633 | 64.1 | 5.14 | |
| 11 | ∞ | 1.00 | 5.20 | | | |
| Image Plane | ∞ | | | | | |

Aspheric Surface Data

| | | |
|---|---|---|
| The 3rd Surface | K = 0.00000e+00 | A4 = 1.00118e−03 |
| | A6 = −6.15049e−05 | A8 = 7.04917e−06 |
| | A10 = −2.31715e−07 | |
| The 4th Surface | K = 0.00000e+00 | A4 = 3.83009e−04 |
| | A6 = −3.36829e−05 | A8 = 6.63844e−06 |
| | A10 = −1.81243e−07 | A12 = −3.59197e−09 |
| The 5th Surface | K = 0.00000e+00 | A4 = −2.33599e−04 |
| | A6 = 2.08784e−05 | A8 = 4.07068e−07 |
| | A10 = 6.07351e−08 | A12 = −5.48356e−09 |
| The 8th Surface | K = 0.00000e+00 | A4 = −1.17038e−03 |
| | A6 = 1.10232e−03 | A8 = −1.63760e−04 |
| | A10 = 3.53382e−05 | A12 = −2.44381e−06 |
| The 9th Surface | K = 0.00000e+00 | A4 = −3.70481e−03 |
| | A6 = 9.02249e−04 | A8 = −1.41582e−04 |
| | A10 = 1.81904e−05 | A12 = −9.81065e−07 |

| | |
|---|---|
| Focal Length | 20.00 |
| F-Number | 3.20 |
| Half Angle of View | 8.00 |
| Image Height | 2.82 |
| BF | 1.00 |

Single Lens Data

| Lens | Beginning Surface | Focal Length |
|---|---|---|
| G1 | 1 | 9.60 |
| G2 | 4 | −22.09 |
| PR | 6 | INF |
| G3 | 8 | −16.86 |
| CG | 10 | INF |

### Numerical Example 3

Unit: mm
Surface Data

| Surface | | | | | Effective | |
|---|---|---|---|---|---|---|
| Number | r | d | nd | νd | Diameter | θgF |
| 1 (Aperture) | ∞ | −0.60 | 6.56 | | | |
| 2 | 5.986 | 1.69 | 1.49700 | 81.5 | 6.56 | 0.5375 |
| 3 | 53.700 | 0.10 | 6.23 | | | |
| 4* | 12.105 | 0.70 | 1.56650 | 37.6 | 5.94 | |
| 5* | 7.936 | 1.75 | 5.39 | | | |
| 6 | ∞ | 18.54 | 1.85150 | 40.8 | 4.97 | |
| 7 | ∞ | 1.00 | 3.85 | | | |
| 8* | −8.335 | 1.00 | 1.68040 | 18.1 | 4.04 | |
| 9* | −36.995 | | 1.00 | 4.50 | | |
| 10 | ∞ | 0.20 | 1.51633 | 64.1 | 5.07 | |
| 11 | ∞ | | 1.00 | 5.14 | | |
| Image Plane | ∞ | | | | | |

Aspheric Surface Data

| | | |
|---|---|---|
| The 4th Surface | K = 0.00000e+00 | A4 = 1.75574e−03 |
| | A6 = −1.80997e−05 | A8 = −1.39975e−06 |
| | A10 = 1.46986e−07 | A12 = −5.49932e−09 |
| The 5th Surface | K = 0.00000e+00 | A4 = 2.68645e−03 |
| | A6 = 2.48935e−05 | A8 = −1.51680e−06 |
| | A10 = 3.16269e−07 | A12 = −6.28611e−09 |
| The 8th Surface | K = 0.00000e+00 | A4 = −4.04157e−03 |
| | A6 = 1.13061e−03 | A8 = −3.21363e−04 |
| | A10 = 5.51540e−05 | A12 = −3.89290e−06 |
| The 9th Surface | K = 0.00000e+00 | A4 = −4.81200e−03 |
| | A6 = 1.44675e−03 | A8 = −3.43042e−04 |
| | A10 = 4.67673e−05 | A12 = −2.58982e−06 |

| | |
|---|---|
| Focal Length | 21.00 |
| F-Number | 3.20 |
| Half Angle of View | 7.57 |
| Image Height | 2.82 |
| BF | 1.00 |

Single Lens Data

| Lens | Beginning Surface | Focal Length |
|---|---|---|
| G1 | 1 | 13.40 |
| G2 | 4 | −43.31 |
| PR | 6 | INF |
| G3 | 8 | −16.04 |
| CG | 10 | INF |

### Numerical Example 4

Unit: mm
Surface Data

| Surface | | | | | Effective | |
|---|---|---|---|---|---|---|
| Number | r | d | nd | νd | Diameter | θgF |
| 1 (Aperture) | ∞ | −0.30 | 6.05 | | | |
| 2 | 4.940 | 1.83 | 1.43875 | 94.7 | 6.05 | 0.5340 |
| 3 | 712.000 | 0.10 | 5.70 | | | |
| 4* | 36.523 | 0.80 | 1.53160 | 55.8 | 5.50 | |
| 5* | 8.324 | 1.83 | 4.88 | | | |
| 6 | ∞ | 20.60 | 1.65844 | 50.9 | 4.49 | |
| 7 | ∞ | 1.00 | 4.35 | | | |
| 8* | −20.511 | 0.80 | 1.68040 | 18.1 | 4.55 | |
| 9* | 23.457 | 0.80 | 4.84 | | | |
| 10 | ∞ | 0.20 | 1.51633 | 64.1 | 5.25 | |
| 11 | ∞ | 0.60 | 5.32 | | | |
| Image Plane | ∞ | | | | | |

Aspheric Surface Data

| | | |
|---|---|---|
| The 4th Surface | K = 0.00000e+00 | A4 = 2.49708e−03 |
| | A6 = −1.38501e−04 | A8 = 6.07311e−06 |
| | A10 = −2.02276e−07 | A12 = 2.06062e−09 |
| The 5th Surface | K = 0.00000e+00 | A4 = 4.13920e−03 |
| | A6 = −6.44642e−05 | A8 = 7.52654e−06 |
| | A10 = 2.36162e−08 | A12 = 1.57357e−08 |
| The 8th Surface | K = 0.00000e+00 | A4 = −6.17242e−03 |
| | A6 = 1.81192e−03 | A8 = −3.78971e−04 |
| | A10 = 4.57495e−05 | A12 = −2.16339e−06 |
| The 9th Surface | K = −7.35985e+02 | A4 = −3.80399e−03 |
| | A6 = 1.11770e−03 | A8 = −2.12468e−04 |
| | A10 = 2.37505e−05 | A12 = −9.51569e−07 |

| | |
|---|---|
| Focal Length | 23.00 |
| F-Number | 3.80 |
| Half Angle of View | 6.96 |
| Image Height | 2.82 |
| BF | 0.60 |

Single Lens Data

| Lens | Beginning Surface | Focal Length |
|---|---|---|
| G1 | 1 | 11.33 |
| G2 | 4 | −20.48 |
| PR | 6 | INF |
| G3 | 8 | −15.96 |
| CG | 10 | INF |

### Numerical Example 5

Unit: mm
Surface Data

| Surface | | | | | Effective | |
|---|---|---|---|---|---|---|
| Number | r | d | nd | νd | Diameter | θgF |
| 1 (Aperture) | ∞ | −0.60 | 7.62 | | | |
| 2 | 5.886 | 2.23 | 1.43875 | 94.7 | 7.62 | 0.5340 |
| 3 | −193.518 | 0.10 | 7.23 | | | |
| 4* | 19.711 | 0.90 | 1.53160 | 55.8 | 6.89 | |
| 5* | 6.979 | 1.27 | 6.04 | | | |
| 6 | ∞ | 26.00 | 1.51742 | 52.4 | 5.91 | |
| 7 | ∞ | 1.00 | 4.05 | | | |
| 8* | −3.718 | 1.00 | 1.58500 | 30.0 | 4.15 | |
| 9* | −6.164 | 1.00 | 4.64 | | | |
| 10 | ∞ | 0.21 | 1.51633 | 64.1 | 5.19 | |
| 11 | ∞ | 1.00 | 5.25 | | | |
| Image Plane | ∞ | | | | | |

Aspheric Surface Data

| | | |
|---|---|---|
| The 4th Surface | K = 0.00000e+00 | A4 = 4.08012e−04 |
| | A6 = −1.39658e−05 | A8 = −8.42602e−07 |
| | A10 = 7.87345e−08 | A12 = −2.13579e−09 |
| The 5th Surface | K = 0.00000e+00 | A4 = 1.16459e−03 |
| | A6 = 1.58312e−05 | A8 = −1.07356e−06 |
| | A10 = 1.57428e−07 | A12 = −4.73728e−10 |
| The 8th Surface | K = 0.00000e+00 | A4 = 1.94150e−03 |
| | A6 = 1.25075e−03 | A8 = −3.77822e−05 |
| | A10 = −2.73605e−05 | A12 = 3.51725e−06 |
| The 9th Surface | K = 0.00000e+00 | A4 = −4.50368e−03 |
| | A6 = 2.44290e−03 | A8 = −3.79254e−04 |
| | A10 = 3.13181e−05 | A12 = −9.43901e−07 |

| | |
|---|---|
| Focal Length | 32.00 |
| F-Number | 4.20 |
| Half Angle of View | 5.08 |
| Image Height | 2.82 |
| BF | 1.00 |

Single

| Lens | Beginning Surface | Focal Length |
|---|---|---|
| G1 | 1 | 13.06 |
| G2 | 4 | −20.83 |
| PR | 6 | INF |
| G3 | 8 | −18.86 |
| CG | 10 | INF |

### Numerical Example 6

Unit: mm
Surface Data

| Surface | | | | | Effective | |
|---|---|---|---|---|---|---|
| Number | r | d | nd | νd | Diameter | θgF |
| 1 (Aperture) | ∞ | −0.40 | 6.61 | | | |
| 2 | 9.002 | 1.59 | 1.52841 | 76.5 | 6.61 | 0.5396 |
| 3 | −31.448 | 0.10 | 6.39 | | | |
| 4* | −138.569 | 0.90 | 1.53160 | 55.8 | 6.26 | |
| 5* | 12.100 | 1.91 | 5.82 | | | |
| 6 | ∞ | 36.67 | 1.63930 | 44.9 | 5.50 | |
| 7 | ∞ | 1.00 | 4.30 | | | |
| 8* | −7.810 | 1.00 | 1.68040 | 18.1 | 4.39 | |
| 9* | −18.000 | 1.50 | 4.77 | | | |
| 10 | ∞ | 0.21 | 1.51633 | 64.1 | 5.29 | |
| 11 | ∞ | 1.00 | 5.34 | | | |
| Image Plane | ∞ | | | | | |

Aspheric Surface Data

| | | |
|---|---|---|
| The 4th Surface | K = 0.00000e+00 | A4 = 3.47300e−04 |
| | A6 = −2.30592e−05 | A8 = 1.72333e−07 |
| | A10 = 6.93445e−08 | A12 = −3.27088e−09 |
| The 5th Surface | K = 0.00000e+00 | A4 = 6.13508e−04 |
| | A6 = −1.93011e−05 | A8 = −6.51319e−07 |
| | A10 = 1.75980e−07 | A12 = −7.82607e−09 |
| The 8th Surface | K = 0.00000e+00 | A4 = −3.76371e−04 |
| | A6 = −1.21534e−03 | A8 = 5.95066e−04 |
| | A10 = −1.11982e−04 | A12 = 7.62471e−06 |
| The 9th Surface | K = 0.00000e+00 | A4 = −1.91897e−03 |
| | A6 = −5.90392e−04 | A8 = 3.35593e−04 |
| | A10 = −5.75874e−05 | A12 = 3.42043e−06 |

| | |
|---|---|
| Focal Length | 37.00 |
| F-Number | 5.60 |
| Half Angle of View | 4.39 |
| Image Height | 2.82 |
| BF | 1.00 |

Single Lens Data

| Lens | Beginning Surface | Focal Length |
|---|---|---|
| G1 | 1 | 13.43 |
| G2 | 4 | −20.89 |
| PR | 6 | INF |
| G3 | 8 | −21.11 |
| CG | 10 | INF |

### Numerical Example 7

Unit: mm
Surface Data

| Surface | | | | | Effective | |
|---|---|---|---|---|---|---|
| Number | r | d | nd | νd | Diameter | θgF |
| 1 (Aperture) | ∞ | −0.60 | 7.14 | | | |
| 2 | 7.332 | 1.75 | 1.43875 | 94.7 | 7.14 | 0.5340 |
| 3 | −325.398 | 0.10 | 6.88 | | | |
| 4* | 30.773 | 0.90 | 1.53160 | 55.8 | 6.70 | |
| 5* | 10.007 | 1.75 | 6.16 | | | |
| 6 | ∞ | 35.50 | 1.51633 | 64.1 | 5.90 | |
| 7 | ∞ | 1.00 | 4.21 | | | |
| 8* | −4.319 | 1.00 | 1.56650 | 37.6 | 4.27 | |
| 9* | −7.673 | 1.50 | 4.71 | | | |
| 10 | ∞ | 0.21 | 1.51633 | 64.1 | 5.29 | |
| 11 | ∞ | 1.00 | 5.33 | | | |
| Image Plane | ∞ | | | | | |

| Aspheric Surface Data | | |
|---|---|---|
| The 4th Surface | K = 0.00000e+00 | A4 = 7.06815e−04 |
| | A6 = −2.02316e−05 | A8 = −2.52351e−07 |
| | A10 = 5.11811e−08 | A12 = −1.49504e−09 |
| The 5th Surface | K = 0.00000e+00 | A4 = 1.10813e−03 |
| | A6 = −9.94206e−06 | A8 = −7.95199e−07 |
| | A10 = 1.03591e−07 | A12 = −2.67370e−09 |
| The 8th Surface | K = 0.00000e+00 | A4 = 3.50582e−04 |
| | A6 = 6.78013e−05 | A8 = 3.68426e−04 |
| | A10 = −9.24970e−05 | A12 = 7.29696e−06 |
| The 9th Surface | K = 0.00000e+00 | A4 = −4.05748e−03 |
| | A6 = 1.03553e−03 | A8 = 1.12606e−05 |
| | A10 = −2.10147e−05 | A12 = 1.74590e−06 |

| | |
|---|---|
| Focal Length | 40.00 |
| F-Number | 5.60 |
| Half Angle of View | 4.08 |
| Image Height | 2.82 |
| BF | 1.00 |

Single Lens Data

| Lens | Beginning Surface | Focal Length |
|---|---|---|
| G1 | 1 | 16.37 |
| G2 | 4 | −28.32 |
| PR | 6 | INF |
| G3 | 8 | −19.55 |
| CG | 10 | INF |

### Numerical Example 8

Unit: mm
Surface Data

| Surface | | | | | Effective | |
|---|---|---|---|---|---|---|
| Number | r | d | nd | νd | Diameter | θgF |
| 1 (Aperture) | ∞ | −0.60 | 7.37 | | | |
| 2 | 8.586 | 1.70 | 1.43875 | 94.7 | 7.37 | 0.5340 |
| 3 | −96.894 | 0.10 | 7.14 | | | |
| 4* | 47.284 | 0.90 | 1.53160 | 55.8 | 6.98 | |
| 5* | 13.255 | 0.96 | 6.51 | | | |
| 6 | ∞ | 37.00 | 1.51633 | 64.1 | 6.41 | |
| 7 | ∞ | 0.58 | 4.17 | | | |
| 8* | −6.412 | 1.00 | 1.63910 | 23.5 | 4.20 | |
| 9* | −8.254 | 1.15 | 4.33 | | | |
| 10* | −21.488 | 0.90 | 1.53160 | 55.8 | 4.48 | |
| 11* | 46.122 | 1.50 | 5.01 | | | |
| 12 | ∞ | 0.21 | 1.51633 | 64.1 | 5.41 | |
| 13 | ∞ | 1.00 | 5.44 | | | |
| Image Plane | ∞ | | | | | |

Aspheric Surface Data

| | | |
|---|---|---|
| The 4th Surface | K = 0.00000e+00 | A4 = 6.54638e−04 |
| | A6 = −1.60169e−05 | A8 = −1.56481e−07 |
| | A10 = 3.10588e−08 | A12 = −8.47571e−10 |
| The 5th Surface | K = 0.00000e+00 | A4 = 9.25860e−04 |
| | A6 = −1.03778e−05 | A8 = −5.12715e−07 |
| | A10 = 5.91497e−08 | A12 = −1.55649e−09 |
| The 8th Surface | K = 0.00000e+00 | A4 = 5.99050e−03 |
| | A6 = 4.01406e−04 | A8 = −4.91665e−05 |
| The 9th Surface | K = 0.00000e+00 | A4 = 1.26995e−03 |
| | A6 = 1.52636e−03 | A8 = −1.30129e−04 |
| The 10th Surface | K = 0.00000e+00 | A4 = −2.59666e−02 |
| | A6 = 7.39712e−04 | A8 = 1.09148e−03 |
| | A10 = −2.47290e−04 | A12 = 1.57904e−05 |
| The 11th Surface | K = 0.00000e+00 | A4 = −2.46972e−02 |
| | A6 = 1.58177e−03 | A8 = 3.24332e−04 |
| | A10 = −7.85983e−05 | A12 = 4.51419e−06 |

| | |
|---|---|
| Focal Length | 42.00 |
| F-Number | 5.70 |
| Half Angle of View | 3.89 |
| Image Height | 2.82 |
| BF | 1.00 |

Single Lens Data

| Lens | Beginning Surface | Focal Length |
|---|---|---|
| G1 | 1 | 18.07 |
| G2 | 4 | −34.97 |
| PR | 6 | INF |
| G3 | 8 | −57.01 |
| G4 | 10 | −27.45 |
| CG | 12 | INF |

### Numerical Example 9

Unit: mm
Surface Data

| Surface | | | | | Effective | |
|---|---|---|---|---|---|---|
| Number | r | d | nd | νd | Diameter | θgF |
| 1 (Aperture) | ∞ | −0.50 | 7.50 | | | |
| 2 | 11.845 | 1.39 | 1.43875 | 94.7 | 7.50 | 0.5340 |
| 3 | 415.393 | 0.15 | 7.34 | | | |
| 4* | 33.878 | 0.90 | 1.53160 | 55.8 | 7.23 | |
| 5* | 17.866 | 2.26 | 6.91 | | | |
| 6 | ∞ | 53.00 | 1.54814 | 45.8 | 6.58 | |
| 7 | −9.404 | 0.49 | 4.68 | | | |
| 8* | −3.899 | 1.00 | 1.61550 | 25.8 | 4.64 | |
| 9* | −11.654 | 1.20 | 4.94 | | | |
| 10 | ∞ | 0.20 | 1.51633 | 64.1 | 5.33 | |
| 11 | ∞ | 1.00 | 5.36 | | | |
| Image Plane | ∞ | | | | | |

Aspheric Surface Data

| | | |
|---|---|---|
| The 4th Surface | K = 0.00000e+00 | A4 = 3.63842e−04 |
| | A6 = 9.69266e−06 | A8 = −1.54277e−06 |
| | A10 = 7.49432e−08 | A12 = −1.30344e−09 |
| The 5th Surface | K = 0.00000e+00 | A4 = 4.57081e−04 |
| | A6 = 1.39761e−05 | A8 = −1.98071e−06 |
| | A10 = 9.75240e−08 | A12 = −1.65566e−09 |
| The 8th Surface | K = 0.00000e+00 | A4 = 6.23521e−03 |
| | A6 = −4.41986e−04 | A8 = 2.19405e−04 |
| | A10 = −4.09779e−05 | A12 = 2.72729e−06 |
| The 9th Surface | K = 1.09699e+01 | A4 = 2.22523e−03 |
| | A6 = 1.06266e−04 | A8 = 1.10923e−04 |
| | A10 = −2.45882e−05 | A12 = 1.63164e−06 |

| | |
|---|---|
| Focal Length | 48.00 |
| F-Number | 6.40 |
| Half Angle of View | 3.37 |
| Image Height | 2.82 |
| BF | 1.00 |

Single Lens Data

| Lens | Beginning Surface | Focal Length |
|---|---|---|
| G1 | 1 | 27.76 |
| G2 | 4 | −72.53 |
| PR | 6 | 17.16 |
| G3 | 8 | −10.01 |
| CG | 10 | INF |

### Numerical Example 10

Unit: mm
Surface Data

| Surface | | | | | Effective | |
|---|---|---|---|---|---|---|
| Number | r | d | nd | νd | Diameter | θgF |
| 1 (Aperture) | ∞ | −0.60 | 7.88 | | | |
| 2 | 10.861 | 1.55 | 1.43875 | 94.7 | 7.88 | 0.5340 |
| 3 | −592.009 | 0.15 | 7.69 | | | |
| 4* | 35.843 | 0.90 | 1.53160 | 55.8 | 7.55 | |
| 5* | 15.021 | 2.10 | 7.16 | | | |
| 6 | ∞ | 53.00 | 1.51823 | 58.9 | | 6.87 |
| 7 | ∞ | 1.00 | 4.47 | | | |
| 8* | −4.723 | 1.00 | 1.63560 | 23.9 | | 4.52 |
| 9* | −7.460 | 1.00 | 4.93 | | | |
| 10 | ∞ | 0.20 | 1.51633 | 64.1 | | 5.30 |
| 11 | ∞ | 1.21 | 5.33 | | | |
| Image Plane | ∞ | | | | | |

Aspheric Surface Data

| | | |
|---|---|---|
| The 4th Surface | K = 0.00000e+00 | A4 = 3.49234e−04 |
| | A6 = 6.24195e−07 | A8 = −6.79011e−07 |
| | A10 = 3.11690e−08 | A12 = −4.58649e−10 |
| The 5th Surface | K = 0.00000e+00 | A4 = 4.64502e−04 |
| | A6 = 3.73767e−06 | A8 = −9.07964e−07 |
| | A10 = 3.97036e−08 | A12 = −4.93724e−10 |
| The 8th Surface | K = 0.00000e+00 | A4 = 2.92096e−03 |
| | A6 = −1.79341e−03 | A8 = 8.32164e−04 |
| | A10 = −1.44501e−04 | A12 = 9.09385e−06 |
| The 9th Surface | K = 3.68952e+00 | A4 = 7.35529e−04 |
| | A6 = −8.87944e−04 | A8 = 4.91587e−04 |
| | A10 = −7.60618e−05 | A12 = 4.17474e−06 |

| | |
|---|---|
| Focal Length | 52.00 |
| F-Number | 6.60 |
| Half Angle of View | 3.13 |
| Image Height | 2.82 |
| BF | 1.21 |

Single Lens Data

| Lens | Beginning Surface | Focal Length |
|---|---|---|
| G1 | 1 | 24.33 |
| G2 | 4 | −49.38 |
| PR | 6 | INF |
| G3 | 8 | −23.61 |
| CG | 10 | INF |

### Numerical Example 11

Unit: mm
Surface Data

| Surface | | | | | Effective | |
|---|---|---|---|---|---|---|
| Number | r | d | nd | νd | Diameter | θgF |
| 1 (Aperture) | ∞ | −0.60 | 7.00 | | | |
| 2 | 6.087 | 1.90 | 1.43875 | 94.7 | 7.00 | 0.5340 |
| 3 | 728.428 | 0.10 | 6.67 | | | |
| 4* | 27.587 | 0.90 | 1.53160 | 55.8 | 6.46 | |
| 5* | 8.305 | 0.95 | 5.78 | | | |
| 6 | ∞ | 28.36 | 1.51633 | 64.1 | 5.71 | |
| 7 | ∞ | 0.30 | 4.84 | | | |
| 8 | 712.208 | 1.11 | 1.77250 | 49.6 | 4.91 | |
| 9 | −15.564 | 1.23 | 5.03 | | | |
| 10 | −7.420 | 0.90 | 1.68040 | 18.1 | 5.00 | |
| 11* | −25.000 | 1.50 | 5.31 | | | |
| 12 | ∞ | 0.21 | 1.51633 | 64.1 | 5.60 | |
| 13 | ∞ | 0.10 | 5.63 | | | |
| Image Plane | ∞ | | | | | |

Aspheric Surface Data

| | | |
|---|---|---|
| The 4th Surface | K = 0.00000e+00 | A4 = 1.12353e−03 |
| | A6 = −4.72651e−05 | A8 = 1.12414e−06 |
| | A10 = 9.66649e−09 | A12 = −1.45372e−09 |
| The 5th Surface | K = 0.00000e+00 | A4 = 1.89926e−03 |
| | A6 = −2.22889e−05 | A8 = 6.43929e−07 |
| | A10 = 1.46870e−07 | A12 = −5.68504e−09 |
| The 10th Surface | K = 0.00000e+00 | A4 = −1.92793e−03 |
| | A6 = 1.41560e−03 | A8 = −4.29194e−04 |
| | A10 = 6.04869e−05 | A12 = −3.26465e−06 |
| The 11th Surface | K = 0.00000e+00 | A4 = −2.55182e−03 |
| | A6 = 1.16588e−03 | A8 = −3.42437e−04 |
| | A10 = 4.37563e−05 | A12 = −2.09926e−06 |

| | |
|---|---|
| Focal Length | 28.00 |
| F-Number | 4.00 |
| Half Angle of View | 5.87 |
| Image Height | 2.82 |
| BF | 0.10 |

Single Lens Data

| Lens | Beginning Surface | Focal Length |
|---|---|---|
| G1 | 1 | 13.98 |
| G2 | 4 | −22.72 |
| PR | 6 | INF |
| G3 | 8 | 19.73 |
| G4 | 10 | −15.84 |
| CG | 12 | INF |

### Numerical Example 12

Unit: mm
Surface Data

| Surface | | | | | Effective | |
|---|---|---|---|---|---|---|
| Number | r | d | nd | νd | Diameter | θgF |
| 1 (Aperture) | ∞ | −0.30 | 5.00 | | | |
| 2* | 6.270 | 1.88 | 1.43875 | 94.7 | 5.00 | 0.5340 |
| 3 | −8.229 | 1.00 | 1.53160 | 55.8 | 4.73 | |
| 4* | −44.100 | 1.62 | 4.44 | | | |
| 5 | ∞ | 11.05 | 1.51633 | 64.1 | 3.84 | |
| 6 | ∞ | 1.50 | 3.43 | | | |
| 7* | −2.248 | 1.00 | 1.61550 | 25.8 | 3.63 | |
| 8* | −3.132 | 1.00 | 4.42 | | | |
| 9 | ∞ | 0.21 | 1.51633 | 64.1 | 5.18 | |
| 10 | ∞ | 1.00 | 5.24 | | | |
| Image Plane | ∞ | | | | | |

Aspheric Surface Data

| | | |
|---|---|---|
| The 2nd Surface | K = 0.00000e+00 | A4 = 1.10533e−04 |
| | A6 = 1.98489e−05 | A8 = −9.20098e−07 |
| | A10 = 2.71971e−07 | A12 = −7.34786e−09 |
| The 4th Surface | K = 0.00000e+00 | A4 = 4.09216e−04 |
| | A6 = 2.12505e−05 | A8 = −2.87683e−07 |
| | A10 = 3.20788e−07 | A12 = −1.28620e−08 |
| The 7th Surface | K = 0.00000e+00 | A4 = 1.41311e−05 |
| | A6 = 4.21221e−03 | A8 = −9.74726e−04 |
| | A10 = 1.87353e−04 | A12 = 9.89164e−07 |
| The 8th Surface | K = 0.00000e+00 | A4 = −3.72747e−03 |
| | A6 = 2.30732e−03 | A8 = −5.31649e−04 |
| | A10 = 7.67853e−05 | A12 = −3.94311e−06 |

| | |
|---|---|
| Focal Length | 18.00 |
| F-Number | 3.60 |
| Half Angle of View | 8.94 |
| Image Height | 2.82 |
| BF | 1.00 |

Single Lens Data

| Lens | Beginning Surface | Focal Length |
|---|---|---|
| G1 | 1 | 8.44 |
| G2 | 3 | −19.22 |
| PR | 5 | INF |
| G3 | 7 | −22.71 |
| CG | 9 | INF |

Numerical values of the above-described physical quantity in each of the examples are illustrated in Table 1, and numerical values of the conditional expressions in each of the examples are illustrated in Table 2.

TABLE 1

| | Example 1 | Example 2 | Example 3 | Example 4 | Example 5 |
|---|---|---|---|---|---|
| NdG1 | 1.43875 | 1.43875 | 1.496999 | 1.43875 | 1.43875 |
| vdG1 | 94.66 | 94.66 | 81.54 | 94.66 | 94.66 |
| f | 20.000 | 20.000 | 21.000 | 23.000 | 32.000 |
| fG1 | 10.678 | 9.599 | 13.398 | 11.329 | 13.064 |
| fG2 | −22.664 | −22.089 | −43.305 | −20.482 | −20.834 |
| fGR | −16.045 | −16.861 | −16.040 | −15.965 | −18.864 |
| G1R1 | 4.731 | 7.591 | 5.986 | 4.940 | 5.886 |
| G1R2 | −411.548 | −8.723 | 53.700 | 712.000 | −193.518 |
| G2R1 | 20.895 | −10.065 | 12.105 | 36.523 | 19.711 |
| G2R2 | 7.528 | −73.130 | 7.936 | 8.324 | 6.979 |
| GRR1 | −6.272 | −3.043 | −8.335 | −20.511 | −3.718 |
| GRR2 | −16.327 | −4.845 | −36.995 | 23.457 | −6.164 |
| θgFG1 | 0.5340 | 0.5340 | 0.5375 | 0.5340 | 0.5340 |
| LD | 4.500 | 4.400 | 4.237 | 4.560 | 4.500 |
| TTL | 23.71 | 23.11 | 26.98 | 28.56 | 34.71 |
| ω | 7.95 | 8.00 | 7.57 | 6.96 | 5.08 |
| EA_OBJ | 6.45 | 6.25 | 6.56 | 6.05 | 7.62 |
| EA_IMG | 4.40 | 4.44 | 4.50 | 4.84 | 4.64 |
| | Example 6 | Example 7 | Example 8 | Example 9 | Example 10 |
| NdG1 | 1.52841 | 1.43875 | 1.43875 | 1.43875 | 1.43875 |
| vdG1 | 76.46 | 94.66 | 94.66 | 94.66 | 94.66 |
| f | 37.000 | 40.000 | 40.000 | 48.000 | 52.000 |
| fG1 | 13.428 | 16.370 | 18.065 | 27.760 | 24.327 |
| fG2 | −20.890 | −28.322 | −34.966 | −72.526 | −49.379 |
| fGR | −21.113 | −19.551 | −27.448 | −10.010 | −23.612 |
| G1R1 | 9.002 | 7.332 | 8.586 | 11.845 | 10.861 |
| G1R2 | −31.448 | −325.398 | −96.894 | 415.393 | −592.009 |
| G2R1 | −138.569 | 30.773 | 47.284 | 33.878 | 35.843 |
| G2R2 | 12.100 | 10.007 | 13.255 | 17.866 | 15.021 |
| GRR1 | −7.810 | −4.319 | −21.488 | −3.899 | −4.723 |
| GRR2 | −18.000 | −7.673 | 46.122 | −11.654 | −7.460 |
| θgFG1 | 0.5396 | 0.5340 | 0.5340 | 0.5340 | 0.5340 |
| LD | 4.500 | 4.500 | 3.659 | 4.700 | 4.700 |
| TTL | 45.88 | 44.71 | 47.00 | 61.59 | 62.11 |
| ω | 4.39 | 4.08 | 3.89 | 3.37 | 3.13 |
| EA_OBJ | 6.61 | 7.14 | 7.37 | 7.50 | 7.88 |
| EA_IMG | 4.77 | 4.71 | 5.01 | 4.94 | 4.93 |

TABLE 2

| | Example | Example | Example | Example | Example |
|---|---|---|---|---|---|
| | 1 | 2 | 3 | 4 | 5 |
| Conditional Expression | 1.43875 | 1.43875 | 1.49700 | 1.43875 | 1.43875 |
| (1) | | | | | |
| Conditional Expression | 94.66 | 94.66 | 81.54 | 94.66 | 94.66 |
| (2) | | | | | |
| Conditional Expression | 1.133 | 1.104 | 2.062 | 0.891 | 0.651 |
| (3) | | | | | |
| Conditional Expression | 0.802 | 0.843 | 0.764 | 0.694 | 0.589 |
| (4) | | | | | |
| Conditional Expression | 0.534 | 0.480 | 0.638 | 0.493 | 0.408 |
| (5) | | | | | |
| Conditional Expression | 1.503 | 1.757 | 1.197 | 1.409 | 1.444 |
| (6) | | | | | |
| Conditional Expression | −0.977 | −0.069 | −1.251 | −1.014 | −0.941 |
| (7) | | | | | |
| Conditional Expression | 2.126 | −1.319 | 4.807 | 1.590 | 2.096 |
| (8) | | | | | |
| Conditional Expression | −2.247 | −4.378 | −1.582 | −0.067 | −4.040 |
| (9) | | | | | |
| Conditional Expression | 0.049 | 0.049 | 0.031 | 0.049 | 0.049 |
| (10) | | | | | |
| Conditional Expression | 0.225 | 0.220 | 0.202 | 0.198 | 0.141 |
| (11) | | | | | |
| Conditional Expression | 1.186 | 1.156 | 1.285 | 1.242 | 1.085 |
| (12) | | | | | |
| Conditional Expression | 7.95 | 8.00 | 7.57 | 6.96 | 5.08 |
| (13) | | | | | |
| Conditional Expression | 0.682 | 0.710 | 0.686 | 0.800 | 0.609 |
| (14) | | | | | |
| | Example | Example | Example | Example | Example |
| | 6 | 7 | 8 | 9 | 10 |
| Conditional Expression | 1.52841 | 1.43875 | 1.43875 | 1.43875 | 1.43875 |
| (1) | | | | | |
| Conditional Expression | 76.46 | 94.66 | 94.66 | 94.66 | 94.66 |
| (2) | | | | | |
| Conditional Expression | 0.565 | 0.708 | 0.874 | 1.511 | 0.950 |
| (3) | | | | | |
| Conditional Expression | 0.571 | 0.489 | 0.686 | 0.209 | 0.454 |
| (4) | | | | | |
| Conditional Expression | 0.363 | 0.409 | 0.452 | 0.578 | 0.468 |
| (5) | | | | | |
| Conditional Expression | 1.572 | 1.194 | 1.519 | 0.361 | 0.971 |
| (6) | | | | | |
| Conditional Expression | −0.555 | −0.956 | −0.837 | −1.059 | −0.964 |
| (7) | | | | | |
| Conditional Expression | 0.839 | 1.964 | 1.779 | 3.232 | 2.443 |
| (8) | | | | | |
| Conditional Expression | −2.533 | −3.575 | −0.364 | −2.005 | −4.452 |
| (9) | | | | | |
| Conditional Expression | 0.024 | 0.049 | 0.049 | 0.049 | 0.049 |
| (10) | | | | | |
| Conditional Expression | 0.122 | 0.113 | 0.091 | 0.098 | 0.090 |
| (11) | | | | | |
| Conditional Expression | 1.240 | 1.118 | 1.175 | 1.283 | 1.194 |
| (12) | | | | | |
| Conditional Expression | 4.39 | 4.08 | 3.89 | 3.37 | 3.13 |
| (13) | | | | | |
| Conditional Expression | 0.722 | 0.660 | 0.680 | 0.659 | 0.626 |
| (14) | | | | | |

### [Folding Optical Element]

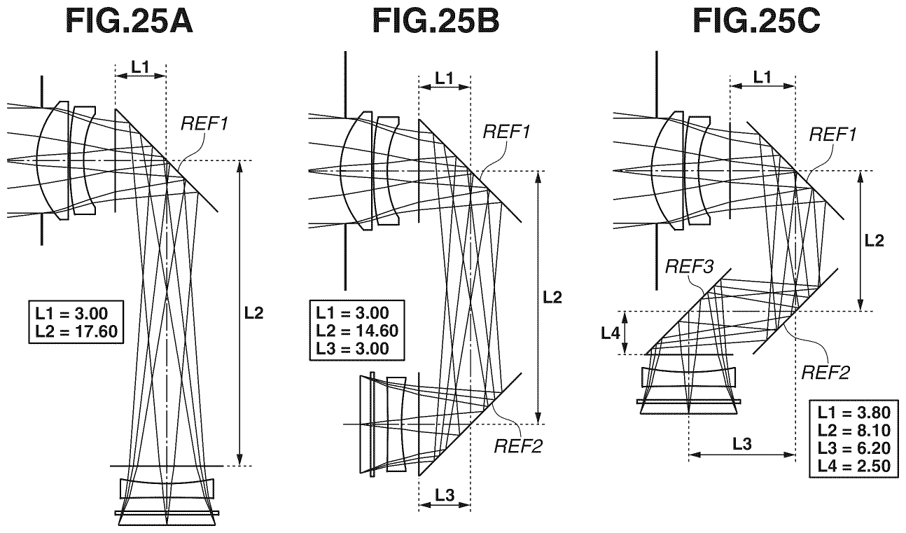

Next, the folding optical element PR of each of the examples is described in detail with reference to FIGS. 25A to 25C. FIGS. 25A to 25C illustrate examples of the configuration of the folding optical element PR included in the optical system L0 of Example 1.

In FIG. 25A, a light ray is folded on a surface REF1 inside the folding optical element PR.

The folding angle is 45°. A numerical value of a distance L1 from the object-side surface to the surface REF1 and a numerical value of a distance L2 from the surface REF1 to the image-side surface of the folding optical element PR are illustrated in FIG. 25A.

In FIG. 25B, a light ray is folded on two surfaces, surfaces REF1 and REF2, inside the folding optical element PR. Both of the folding angles are 45°. A numerical value of a distance L1 from the object-side surface to the surface REF1, a numerical value of a distance L2 from the surface REF1 to the surface REF2, and a numerical value of a distance L3 from the surface REF2 to the image-side surface of the folding optical element PR are illustrated in FIG. 25B.

In FIG. 25C, a light ray is folded on three surfaces, surfaces REF1, REF2, and REF3, inside the folding optical element PR. These folding angles are 45°. A numerical value of a distance L1 from the object-side surface to the surface REF1, a numerical value of a distance L2 from the surface REF1 to the surface REF2, a numerical value of a distance L3 from the surface REF2 to the surface REF3, and a numerical value of a distance L4 from the surface REF3 to the image-side surface of the folding optical element PR are illustrated in FIG. 25C.

As illustrated in FIGS. 25A to 25C, even if a light ray is folded at any angle by any number of times within a folding optical element, acquired aberration diagrams become the same if the total optical axis distance within the folding optical element is the same. Therefore, the optical systems can be regarded as the same image capturing optical system.

In the present embodiment, a prism is used as an example of the folding optical element PR. However, a mirror may be used instead of a prism. Further, a reflection angle of the prism or the mirror may be 30°, 60°, or the other angle instead of 45°. Furthermore, a reflection surface of the prism or the mirror may be a curved surface or an aspheric surface.

### [Image Capturing Apparatus]

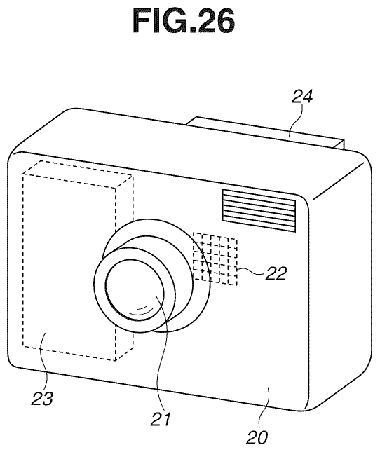

Next, an example of an image capturing apparatus using the optical system L0 of each of the examples as an image capturing optical system is described with reference to FIG. 26. In FIG. 26, a camera body 20 includes an image capturing optical system 21 similar to any of the optical systems L0 described in Examples 1 to 12, and a solid-state image sensor (photoelectric conversion element) 22 built into the camera body 20, which receives light of an object image formed by the image capturing optical system 21. The solid-state image sensor 22 is a sensor such as a CCD sensor or a CMOS sensor. A memory 23 is a recording unit for recording an object image of light received by the image sensor 22. A viewfinder 24 is used to observe an object image formed on the image sensor 22 and displayed on a display element (not illustrated).

The camera body 20 may be a single-lens reflex camera having an instant return mirror, a mirrorless camera without having the instant return mirror, or a camera built into a mobile terminal such as a smartphone.

The above-described solid-state image sensor 22 may be perpendicular to or inclined toward the incident light. In this case, it is desirable that an inclination angle of the solid-state image sensor 22 to the incident light and an inclination angle of the reflection surface of the folding optical element PR be set as appropriate depending on the configuration of the optical system L0 and the image capturing apparatus.

As described above, by applying the optical system L0 of each of the examples to an image capturing apparatus such as a digital still camera, it is possible to acquire an image capturing optical system with high optical performance and reduction in size/weight, and an image capturing apparatus including the image capturing optical system.

While the embodiments and examples disclosed in the present specification have been described, the present disclosure is not limited to the disclosed embodiments and examples, and various combinations, variations, and modifications are possible within the scope of the present disclosure.

In the optical system L0 of each of the examples, all or a part of the lenses included in the optical system L0 may be used as an image-stabilizing lens unit, and an image-stabilization function may be provided by moving the image-capturing surface in a direction parallel to the optical axis.

In the optical system L0 of each of the examples, all or a part of the lenses included in the optical system L0 may be used for focusing.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-016871, filed Feb. 4, 2025, which is hereby incorporated by reference herein in its entirety.

What is claimed is:

1. An optical system comprising, in order from an object side to an image side, a first lens having positive refractive power, a second lens having negative refractive power, a folding optical element, and a rear lens having negative refractive power,
wherein the second lens is disposed adjacent to the first lens on the image side, and
wherein the following conditional expressions are satisfied:
1.30<NdG1<1.60
73.0<νdG1<120.0
where NdG1 is a refractive index of a material of the first lens, and νdG1 is an Abbe number of the material of the first lens for a d-line.

2. The optical system according to claim 1, wherein the following conditional expression is satisfied:
0.20<|fG2/f|<4.00
where fG2 is a focal length of the second lens and f is a focal length of the entire optical system.

3. The optical system according to claim 1, wherein the following conditional expression is satisfied:
0.10<|fGR/f|<2.00
where fGR is a focal length of the rear lens and f is a focal length of the entire optical system.

4. The optical system according to claim 1, wherein the folding optical element is arranged next to the second lens on the image side.

5. The optical system according to claim 1, wherein the following conditional expression is satisfied:
0.20<fG1/f<1.00
where fG1 is a focal length of the first lens and f is a focal length of the entire optical system.

6. The optical system according to claim 1, wherein the following conditional expression is satisfied:
0.20<|fGR/fG1|<3.00
where fG1 is a focal length of the first lens and fGR is a focal length of the rear lens.

7. The optical system according to claim 1, wherein the following conditional expression is satisfied:
−0.20<(G1R1+G1R2)/(G1R1−G1R2)<0.50
where G1R1 is a curvature radius of an object-side lens surface of the first lens, and G1R2 is a curvature radius of an image-side lens surface of the first lens.

8. The optical system according to claim 1, wherein the following conditional expression is satisfied:
−3.00<(G2R1+G2R2)/(G2R1−G2R2)<7.00
where G2R1 is a curvature radius of an object-side lens surface of the second lens, and G2R2 is a curvature radius of an image-side lens surface of the second lens.

9. The optical system according to claim 1, wherein the following conditional expression is satisfied:
−8.00<(GRR1+GRR2)/(GRR1−GRR2)<1.00
where GRR1 is a curvature radius of an object-side lens surface of the rear lens, and GRR2 is a curvature radius of an image-side lens surface of the rear lens.

10. The optical system according to claim 1, wherein the following conditional expression is satisfied:
0.005<θgFG1−0.6438+0.001682×νdG1<0.100
where θgFG1 is a partial dispersion ratio of a material of the first lens.

11. The optical system according to claim 1, wherein the following conditional expression is satisfied:
0.01<LD/f<0.60
where LD is a distance from the object-side lens surface of the first lens to an object-side surface of the folding optical element on an optical axis, and f is a focal length of the entire optical system.

12. The optical system according to claim 1, wherein the following conditional expression is satisfied:
0.40<TTL/f<4.00
where TTL is a total optical length of the optical system and f is a focal length of the entire optical system.

13. The optical system according to claim 1, wherein the following conditional expression is satisfied:
1<ω<20
where ω is an imaging half-angle of view [° ] of the optical system.

14. The optical system according to claim 1, wherein the following conditional expression is satisfied:
0.20<EA_IMG/EA_OBJ<1.00
where EA_OBJ is a light ray effective diameter of an object-side lens surface of a lens arranged closest to the object side of the optical system, and EA_IMG is a light ray effective diameter of an image-side lens surface of a lens arranged closest to the image side of the optical system.

15. The optical system according to claim 1, wherein the second lens has an aspheric shape.

16. The optical system according to claim 15, wherein the aspheric shape of the second lens is an aspheric shape for strengthening negative refractive power toward a circumference from an optical axis center.

17. The optical system according to claim 1, wherein the rear lens has an aspheric shape.

18. The optical system according to claim 17, wherein the aspheric shape of the rear lens is an aspheric shape for strengthening negative refractive power toward a circumference from an optical axis center.

19. The optical system according to claim 1, wherein the folding optical element reflects an incident light ray inside the folding optical element for a plurality of times.

20. The optical system according to claim 1, wherein the number of lenses included in the optical system is four or less.

21. The optical system according to claim 1, comprising the first lens, the second lens, the folding optical element, and the rear lens, sequentially arranged from an object side to an image side.

22. The optical system according to claim 1, comprising the first lens, the second lens, the folding optical element, a third lens having negative refractive power, and a fourth lens having negative refractive power, sequentially arranged from an object side to an image side,
wherein at least one of the third lens and the fourth lens is the rear lens.

23. The optical system according to claim 1, comprising the first lens, the second lens, the folding optical element, a third lens having positive refractive power, and the rear lens, sequentially arranged from an object side to an image side.

24. An image capturing apparatus comprising an optical system and an image sensor for receiving light of an image formed by the optical system,
wherein the optical system includes a first lens having positive refractive power, a second lens having negative refractive power, a folding optical element, and a rear lens having negative refractive power, sequentially arranged from an object side to an image side,
wherein the second lens is arranged next to the first lens on the image side, and
wherein the following conditional expressions are satisfied:
1.30<NdG1<1.60
73.0<νdG1<120.0
where NdG1 is a refractive index of a material of the first lens, and νdG1 is an Abbe number of the material of the first lens for a d-line.
